(19) United States
(12) Patent Application Publication
(10) Pub. No.: US 2020/0102043 A1
(43) Pub. Date: Apr. 2, 2020

(54) ROBOTIC STEERING MECHANISM FOR AUTONOMOUS BICYCLE

(71) Applicants: Wenlong ZHANG, Mesa, AZ (US); Skyler MOORE, Holbrook, AZ (US); Jonathan BUSH, Vancouver, WA (US); Miles MABEY, Prescott Valley, AZ (US); Wenhao DENG, Mesa, AZ (US)

(72) Inventors: Wenlong ZHANG, Mesa, AZ (US); Skyler MOORE, Holbrook, AZ (US); Jonathan BUSH, Vancouver, WA (US); Miles MABEY, Prescott Valley, AZ (US); Wenhao DENG, Mesa, AZ (US)

(73) Assignee: Arizona Board of Regents on Behalf of Arizona State University, Scottsdale, AZ (US)

(21) Appl. No.: 16/586,468

(22) Filed: Sep. 27, 2019

Related U.S. Application Data
(60) Provisional application No. 62/738,909, filed on Sep. 28, 2018.

(51) Int. Cl. B62K 21/00; B62D 37/06

(52) U.S. Cl. CPC B62K 21/00; B62J 7/04; B62K 2207/02; B62D 37/06

(57) ABSTRACT

A self-balancing bicycle system is provided by the present disclosure. The system includes a bicycle, a sensor coupled to the bicycle, a steering control assembly comprising an actuator and being coupled to the bicycle and configured to adjust a steering angle of a front tire of the bicycle, and a controller coupled to the sensor and configured to receive a value from the sensor. The controller is further coupled to the steering control assembly and further configured to adjust the steering angle based on the value.

### RELATED APPLICATIONS

This application is based on, claims priority to, and incorporates herein by reference in its entirety, U.S. Provisional Application No. 62/738,909, filed Sep. 28, 2018, and entitled “Robotic Steering Mechanism for Autonomous Bicycle.”

### STATEMENT REGARDING FEDERALLY SPONSORED RESEARCH

Not Applicable.

### BACKGROUND

In recent years, researchers from both academia and industry have worked on connected and automated vehicles and they have made great progress toward bringing them into reality. Compared to automated cars, bicycles are more affordable to daily commuters, as well as more environmentally friendly. When comparing the risk posed by autonomous vehicles to pedestrians and motorists, automated bicycles are much safer than autonomous cars, which also allows potential applications in smart cities, rehabilitation, and exercise.

Connected and autonomous vehicles have many potential benefits over conventional vehicles including reduced vehicle fatalities and injuries, reduced carbon dioxide emissions, increased vehicle energy efficiency, and improved accessibility to transportation. Compared to cars, bicycles have many advantages in both commercial and research cases. For example, bicycles have more maneuverability in cities, which makes the bicycle a good tool for solving modern mobility challenges in smart cities. Bicycles are also more affordable and environmentally friendly, which has led to a rapid global development in bike sharing systems. Moreover, bicycles are safer for pedestrians and other road users due to their light weights and relatively low speeds compared to cars and motorcycles.

A major challenge in automating bicycles, which is distinct from the various problems inhibiting automation of cars, is the inherent problem of keeping the bicycle balanced. Previous methods have tried to overcome this problem, all with drawbacks. A bicycle can use a mass balancing system to achieve self-balance. This system can only provide a small amount of torque, which can cause low performance. A reaction wheel system can be used to self-balance a bicycle. Unfortunately, this system has a limited amount of output torque, and is therefore only suitable for balancing a small bicycle.

A device that effectively and reliably self-balances a bicycle is therefore desired. Systems and methods of a self-balancing device for a bicycle are described herein.

### SUMMARY

The present disclosure overcomes the aforementioned drawbacks by providing devices and methods that use a self-balancing bicycle system including a bicycle, a balance control system including a controller with a balance control algorithm configured to control motion of the bicycle, a steering control assembly coupled to the balance control system, and an inertial measurement unit (IMU) sensor coupled to the balance control system.

Additionally, a control motion gyroscope (CMG) assembly including two CMG's, a gimballing servo motor, and a controller configured to control the orientation and/or velocity of the CMG's is disclosed.

A CMG assembly can also be included in the self-balancing bicycle system. The CMG assembly provides a high level of torque, allowing a large bicycle with a passenger to be effectively and reliably self-balanced. The self-balancing bicycle system can be coupled to one or more sensors can include a LIDAR sensor, an IMU, a camera, Hall Effect sensors, GPS sensor, throttle sensor, torque sensor, or any other appropriate sensor to measure data related to a position, velocity, location, or surrounding terrain of the bicycle. The one or more sensors can also be a human sensing element such as a weight sensor. The bicycle can have a propulsion motor configured to propel the bicycle. The motor can be mounted on a rear hub of the bicycle. Additionally, the controller can be configured to control an actuator system. The actuator system can include one or more actuators that can control various systems of the bicycle. The one or more actuators can control steering control systems, braking control systems, propulsion motor control systems, lighting control systems, or any appropriate bicycle system that can be controlled by the controller. The one or more actuators can include motors, servo motors, solenoid valves, lights, LED's, or any device that can be controlled by the controller.

In one aspect, a self-balancing bicycle system is provided by the present disclosure. The system includes a bicycle, a sensor coupled to the bicycle, a steering control assembly including an actuator and being coupled to the bicycle and configured to adjust a steering angle of a front tire of the bicycle, and a controller coupled to the sensor and configured to receive a value from the sensor, the controller further coupled to the steering control assembly and further configured to adjust the steering angle based on the value.

In the system, the sensor can be an inertial measurement unit and the value can be a roll angle value of the bicycle.

In the system, the controller can be coupled to the actuator and further configured to calculate an actuator angle value based on the roll angle value and a predetermined target roll angle, and actuate the actuator to the angle value.

In the system, the sensor can be an encoder and the value can be a sensed steering angle value of the bicycle.

The system can further include a control motion gyroscope (CMG) assembly coupled to the bicycle, the CMG assembly including a control motion gyroscope and a motor configured to adjust the orientation of the at least one control motion gyroscope, the CMG assembly being configured to provide a restoring force to the bicycle. The bicycle can include a back rack, and the CMG assembly can be directly coupled to the back rack.

In the system, the steering assembly can further include a first gear coupled to the actuator and configured to be rotated by the actuator, and a second gear coupled to a steering column of the bicycle and engaged with the first gear, and the controller can be further configured to actuate the actuator based on the value. The first gear may have less teeth than the second gear. The steering control assembly can be configured to allow an operator to manually control steering of the bicycle.

The system can further include a control motion gyroscope (CMG) assembly coupled to the bicycle, the CMG assembly including at least two control motion gyroscopes, each gyroscope comprising a flywheel and a flywheel motor, the CMG assembly being configured to provide a restoring force of at least 250 Newtons.

In another aspect, a self-balancing bicycle system including a bicycle, a sensor coupled to the bicycle, a control motion gyroscope (CMG) assembly coupled to the bicycle is provided by the present disclosure. The CMG assembly includes a control motion gyroscope and a motor configured to adjust the orientation of the at least one control motion gyroscope, the CMG assembly being configured to provide a restoring force to the bicycle.

In the system, the CMG assembly can include a second control motion gyroscope including a flywheel and a flywheel motor, and the CMG assembly can be configured to provide a restoring force of at least 250 Newtons.

In the system, the bicycle can include a back rack, and the CMG assembly can be directly coupled to the back rack.

The system can further include a sensor coupled to the bicycle, a steering control assembly including an actuator, the steering control assembly being coupled to the bicycle and configured to adjust a steering angle of a front tire of the bicycle, and a controller coupled to the sensor and the steering control assembly, the sensor being configured to receive a value from the sensor, the controller being further configured to adjust the steering angle based on the value. The steering assembly can further include a first gear coupled to the actuator and configured to be rotated by the actuator, and a second gear coupled to a steering column of the bicycle and engaged with the first gear, the controller being further configured actuate the actuator based on the value. The first gear may have less teeth than the second gear. The steering control assembly can be configured to allow an operator to manually control steering of the bicycle. The sensor can be an inertial measurement unit and the value can be a roll angle value of the bicycle.

In yet another aspect, a method for balancing a bicycle is provided by the present disclosure. The method includes receiving a roll angle value from a sensor coupled to the bicycle, calculating an actuator angle value based on the roll angle value and a predetermined target roll angle, and actuating an actuator coupled to a steering assembly to the actuator angle value, the steering assembly comprising at least two gears.

The method can further include actuating at least one motor included in a control motion gyroscope (CMG) assembly to a predetermined speed, the CMG assembly being coupled to a back rack of the bicycle and configured to provide a restoring force to the bicycle.

The foregoing and other advantages of the invention will appear from the following description. In the description, reference is made to the accompanying drawings, which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

FIG. 1 shows an embodiment of a self-balancing bicycle system.

FIG. 2 shows an exemplary embodiment of the control housing of FIG. 1.

FIG. 3 shows an exemplary block diagram of an electrical system of a self-balancing bicycle system.

FIG. 4 shows an exemplary embodiment of a steering control assembly of a bicycle.

FIG. 5A shows an exploded view of an exemplary embodiment of a CMG assembly.

FIG. 5B shows a cross sectional view through the middle of the CMG assembly in FIG. 5A.

FIG. 5C shows an assembled view of the CMG assembly in FIG. 5A.

FIG. 6 shows an exemplary embodiment of a balance control system of a bicycle.

FIG. 7 shows an exemplary control systems design, with the balance control algorithm and the actuator control on the bicycle.

FIG. 8 shows an exemplary bicycle structure with corresponding parameters labeled

FIG. 9A shows a graph of close-loop analysis of testing at 2.6 m/s.

FIG. 9B shows a graph of experimental results of the testing at 2.6 m/s.

FIG. 10A shows a graph of close-loop analysis of testing at 4.6 m/s.

FIG. 10B shows a graph of experimental results of the testing at 4.6 m/s.

FIG. 11A shows a graph of closed-loop analysis of testing at 5.2 m/s.

FIG. 11B shows a graph of experimental results of the testing at 5.2 m/s.

FIG. 12 shows an exemplary process for balancing a bicycle.

### DETAILED DESCRIPTION

Embodiments of systems, devices, and methods in accordance with the present disclosure provide a self-balancing bicycle system that may include a bicycle, a balance control system including a controller with a balance control algorithm configured to control motion of the bicycle, a steering control assembly coupled to the balance control system, and an IMU sensor coupled to the balance control system. Also disclosed is a control moment gyroscope assembly for use in a self-balancing bicycle system.

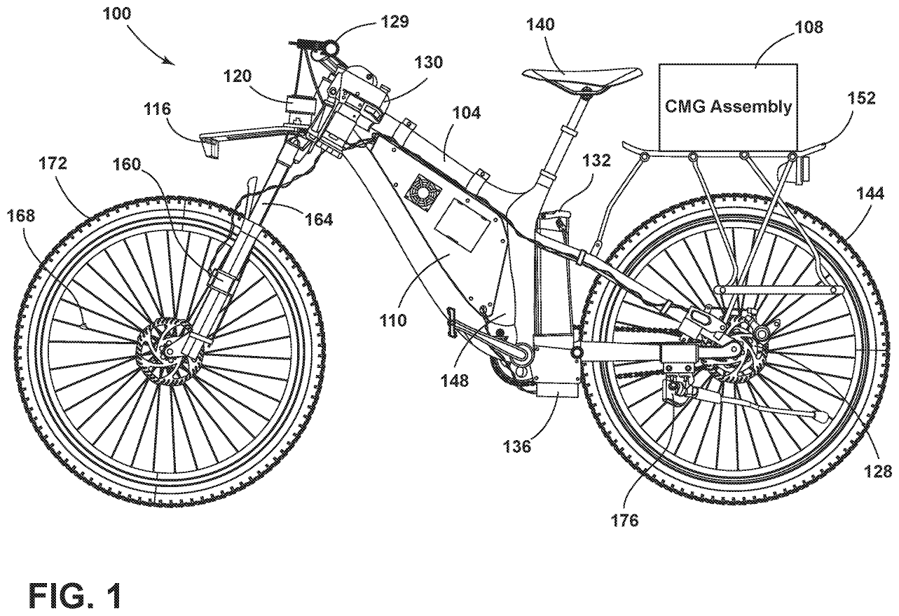

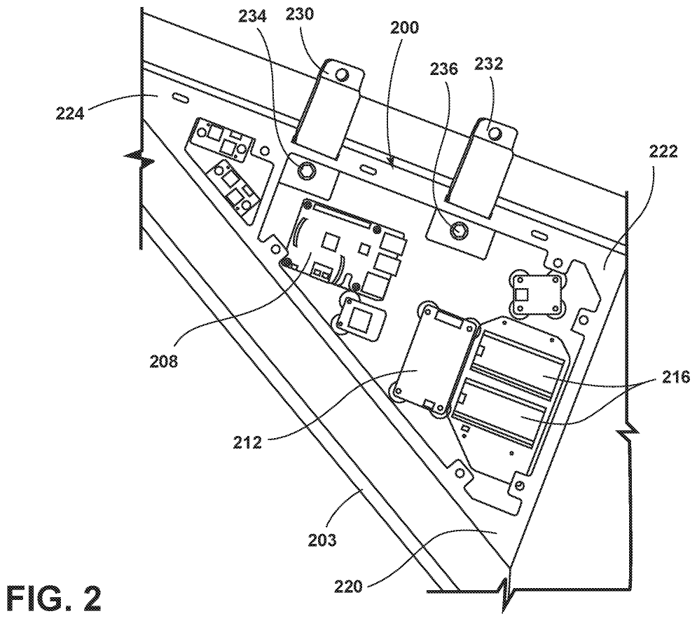

Referring now to FIG. 1, an embodiment of a self-balancing bicycle system 100 is shown. A bicycle 104 can be attached to a control moment gyroscope (CMG) assembly 108. A control housing 110 can enclose a controller (see FIG. 2) configured to control the CMG assembly 108. The control housing 110 can be compact or otherwise can have a small volume such that the control housing 110 is not only unobtrusive to the rider's operation of the bicycle 104, but also does not noticeably impact the balance of the bicycle 104. A camera 116, such as an RGB camera, can be coupled to the controller. The camera 116 can be mounted near the front of the bicycle 104 in order to sense an environment of the bicycle 104. A LIDAR sensor 120 can be coupled to the controller. The LIDAR sensor 120 be mounted near the front of the bicycle 104 in order to detect objects in the path of the bicycle 104. A brake control system 124 can be coupled to the controller. A propulsion motor system 128 can be coupled to the controller. The propulsion motor system 128 can have a throttle control 129. A steering control system 130 can be coupled to the controller. A battery 132 can be coupled to the CMG assembly 108 and to the controller. The battery 132 can be coupled to a power rail 136.

In an embodiment of FIG. 1, the bicycle 104 can be a mountain bike. In this embodiment, the propulsion motor system 128 includes a 300 W electric motor. The propulsion motor system 128 can provide power to propel the bicycle a human rider, and any required control systems and/or actuators. The propulsion motor system 128 may provide enough power to propel the bicycle without input (e.g. “pedaling”) from the human rider. In some embodiments, the propulsion motor system 128 can be coupled to a controller in order to allow a balance control process to selectively control the propulsion motor system 128 to maintain a minimum speed. The minimum speed can correspond to a speed at which the CMG assembly and/or steering control system can balance the bicycle 104 without input from the human rider. In this embodiment, the battery 132 is placed between a seat 140 and a back tire 144, which leaves a center triangle 148 and a back rack 152 of the bicycle 104 free for control system hardware or other equipment. For example, the control housing 110 can be mounted in the center triangle 148 and the CMG assembly 108 can be mounted or otherwise coupled to the back rack 152, as shown. The battery 132 can also be removable, which allows the battery 132 to be swapped for a fully-charged second battery instead of a user needing to wait to recharge the battery 132.

A speed sensor 160 can be coupled to the controller. The speed sensor 160 can be a Hall Effect sensor. In one embodiment, the speed sensor 160 can be mounted on forks 164 of the bike. Magnets 168 can be mounted on spokes of a wheel 172. There can be three magnets 168. The speed sensor 160 can accurately measure revolutions-per-minute (RPMs) of the front wheel 172 using the magnets 168. This configuration allows the controller to accurately calculate a speed of the bicycle 104. Other sensors not illustrated in FIG. 1 may nevertheless be included in the self-balancing bicycle system 100. For example, the system 100 may include one or more inertial measurement unit (IMU) sensors, such as a human IMU sensor configured to sense a motion of a human rider of the bicycle 104 and/or a bicycle IMU sensor mounted to a frame of the bicycle 104 in order to sense a roll angle value of the bicycle 104. It is contemplated that a bicycle kickstand 176 could be coupled to a servo motor (not shown) that is coupled to the controller. The servo motor can then be used to actuate the kickstand 176 on an appropriate signal from the controller. This is intended so the bicycle 104 can rest upright without electrical systems such as the steering control system 130 and/or the CMG assembly 108 activated.

Turning now to FIG. 2, an exemplary embodiment of the control housing of FIG. 1 is shown. A control housing 200 that can house various electronics, including a controller 208 for automatically controlling the systems of a bicycle 203 as described herein, may be 3-D printed. The control housing 200 can be sized for mounting on the frame (e.g., to fit in a center triangle as shown in FIG. 1) of a bicycle 203 without interfering with pedaling the bicycle 203. The placement of this housing 200 allows for clean wiring of the controller 208 to actuators, sensors, motors, and other peripherals that send and/or receive signals to/from the controller 208. Additionally, this placement allows a CMG assembly to be mounted on a rear rack of the bicycle 203 as described above with respect to FIG. 1. The control housing 200 can have a hole (not shown) at each corner 220, 222, 224 of the housing 200 to allow wires to be routed easily. The control housing 200 can be attached to the bicycle 203 frame using any suitable mechanical attachment means that hold the control housing 200 securely even on uneven terrain or in the event of a crash. For example, the control housing 200 may be mounted using two upper clamps 230, 232 disposed around a top bar and two screws 234, 236 attaching the control housing 200 to the clamps 230, 232. The control housing 200 can include mounting points for any of the electronics that act as standoffs to allow for clean wiring to peripheral devices, resulting in easier troubleshooting and reliable operation.

The controller 208 can include one or more control circuits. In some embodiments, the controller 208 can be coupled to additional controllers 212, 216; each controller 208, 212, 216 may be selected due to various I/O capabilities, wireless communication capabilities, processing power, or any other parameter that may be required for implementing a control system for a bicycle. In the illustrated embodiment, there is a first controller 208, a second controller 212, and a third controller 216. The controller(s) 208, 212, 216 can be electrically connected to a power source; for example, the controller(s) 208, 212, 216 may connect to the battery 132 of FIG. 1 through one or more buck converters 240 that step down voltage from the battery 132 for supply to the controller(s) 208, 212, 216. The controller(s) 208, 212, 216 can further be electrically connected to the peripherals to/from which the controller 208, 212, 216 sends (e.g., CMG assembly 108, steering control system 130 of FIG. 1) and/or receives (e.g., sensors 120, 160) signals. A lid of the control housing 200 can have mounting points for a fan which can provide cooling for the controller(s) 208, 212, 216 (see FIG. 1; the lid supporting the fan is removed from the housing 200 in FIG. 2). The fan can be, for example, a 60 mm fan. The fan can be connected directly to the power source (e.g., battery 132 of FIG. 1), or to one of the controllers 208, 212, 216 for receiving its power and/or control signals.

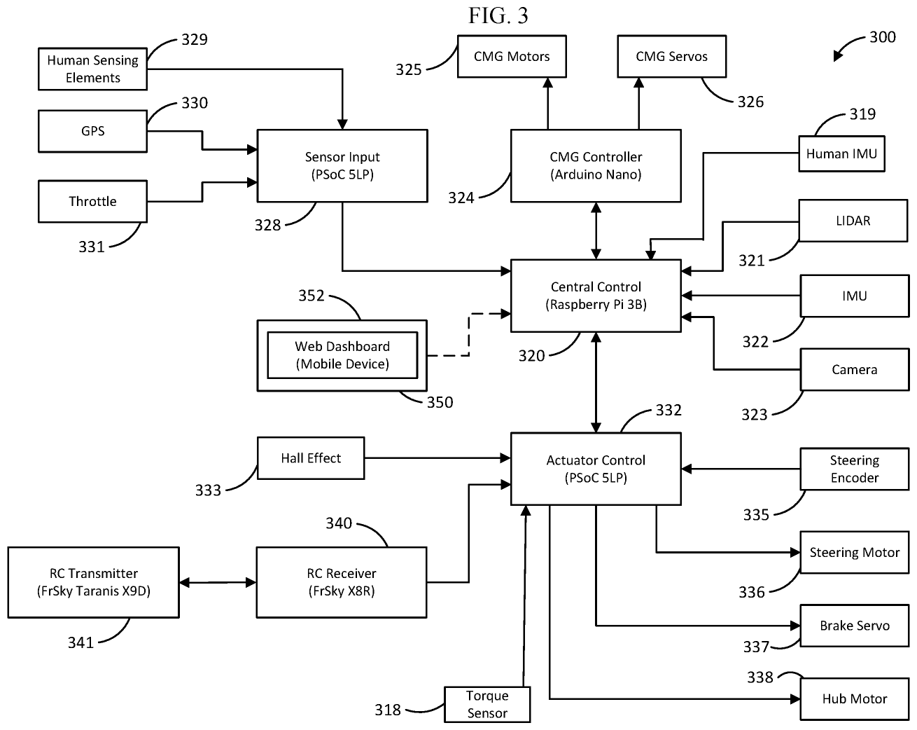

The first controller 208 can be a micro-computer, such as a Raspberry Pi B or another single-board computer with a suitably small footprint. The first controller 208 can be a central control that communicates with various peripherals (e.g., sensors, networked user computing devices) and with the other controllers 212, 216 as described below with respect to FIG. 3. The second controller 212 can be a micro-computer, such as an Arduino Nano or another suitable complete single-board, application-specific computer with a suitably small footprint. The second controller 212 may serve as a motor controller of the CMG assembly. The third controller 216 can be one or more programmable-system-on-chip (PSoC) microcontrollers (e.g., a dual PSoC 5LP on a custom printed circuit board as shown) with specific programming to control and/or otherwise interface with other systems of the bicycle (such as described below by example with respect to FIG. 3). In an alternative embodiment, a controller can be a single custom controller that includes the functionality of controllers 208, 212, and/or 216.

Turning now to FIG. 3, a block diagram of an example electrical system 300 for a self-balancing bicycle is shown. The various components of the electrical system 300 can be powered by a power rail (electrical connections of the power rail represented by arrows in the diagram). The power rail can be coupled to a battery, and can include one or more buck converters in order to supply enough current for the electrical system 300, as described above. The electrical system 300 can include a control circuit 310 defined by the electrical system's 300 controllers (and, optionally, other integrated circuits) and the interfaces between them. For example, the control circuit 310 can include a central controller 320, a CMG controller 324 in electrical communication with the central controller 320, a sensor input controller 328 in electrical communication with the central controller 320, an actuator controller 332 in electrical communication with the central controller 320, and a radio control (RC) receiver 340 in electrical communication with the actuator controller 332. The control circuit 310 can be contained within a control housing, such as the control housing 200 of FIG. 2.

The controllers can be any suitable microcontroller, including the single-board computers and PSoC microcontrollers used as examples herein, having the desired combinations of functionality, energy consumption, footprint, and cost. In the illustrated electrical system 300, there are four controllers, but more or fewer controllers are contemplated. The central controller 320 can be coupled to various sensors, such as a LIDAR sensor 321, an IMU sensor 322, a camera 323, and/or a human IMU sensor 319, and can receive and process sensor data therefrom. For example, the central controller 320 can receive signals from the human IMU sensor 319 (representing sensed motion of the human rider) and the IMU sensor 322 (representing sensed angular “tipping” motion of the bicycle frame); the sensed motions of the human IMU sensor 319 and the IMU sensor 322 can then be compared in order to calculate a motion of the human rider relative to the motion of the bicycle. The first controller 320 can, for example, be a Raspberry Pi 3B. A second controller 324 can be coupled to one or more CMG motors 325 and/or one or more CMG servo motors 326. The CMG motors 325 and/or the CMG servo motors 326 can be part of a CMG assembly as described above. The second controller 324 can be, for example, an Arduino Nano board. The second controller 324 can be coupled to the first controller 320. A third controller 328 can be coupled to one or more human sensing elements 329, a GPS sensor 330, and/or a throttle input 331. The third controller 328 can be, for example a PSoC 5LP. The third controller 328 can be coupled to the first controller 320. The IMU sensor 322 can be coupled to the third controller 328. A fourth controller 332 can be coupled to a Hall Effect sensor 333 for measuring a speed of the bicycle, a steering encoder 335 for sensing a steering angle value of handlebars of the bicycle, a steering control system 336, a braking control system 337, a propulsion motor system 338, and/or a torque sensor 318 configured to sense a torque applied to handlebars of the bicycle. The torque sensor 318 can also be coupled to the third controller 328. The torque sensor 318 can be mounted between a stem of the handlebars and a steering tube of the bicycle frame. The fourth controller 332 can be coupled to the first controller 320. The fourth controller 332 can be a PSoC 5LP. In one embodiment, the third controller 328 and fourth controller 332 are the dual PSoC's of the third controller 216 of FIG. 2. The fourth controller 332 can further be coupled to an RC receiver 340. The RC receiver 340 can receive radio signals from a RC transmitter 341. In one example, the RC receiver 340 can be a FrSky X8R and the RC transmitter 341 can be a FrSky Taranis X9D.

The high-level control of the self-balancing bicycle system and image processing can be performed on the first controller 320. The controller can be programmed in any appropriate language, such as Python, Java, C, C++, or the like. The first controller 320 can use a computer network and associated protocols, such as Wi-Fi, to communicate with a custom user interface 350 on a remote computer 352. The remote computer 352 can be, for example, an Android tablet. The interface 350 can display real-time information about the bicycle such as a speed, direction, and GPS location on a map. Certain control parameters such as the PID control gain can be tuned using the interface 350. The first controller 320 can communicate with the IMU sensor 322 to receive parameters such as specific force (acceleration), angular rates, and magnetic field in the frame of the bicycle. The first controller 320 can also receive a steering angle value from the steering encoder 335 via the fourth controller 332. The IMU sensor 322 can be a PhidgetSpatial 3/3/3 IMU, and communication can take place using a USB connection. The third controller 328 can receive GPS data from the GPS sensor 330, and send the GPS data to the first controller 320. The GPS sensor 330 can be an Adafruit GPS module. The first controller 320 can send commands to the fourth controller 332 in order to actuate the steering control system 336, the braking control system 337 and/or the propulsion motor system 338.

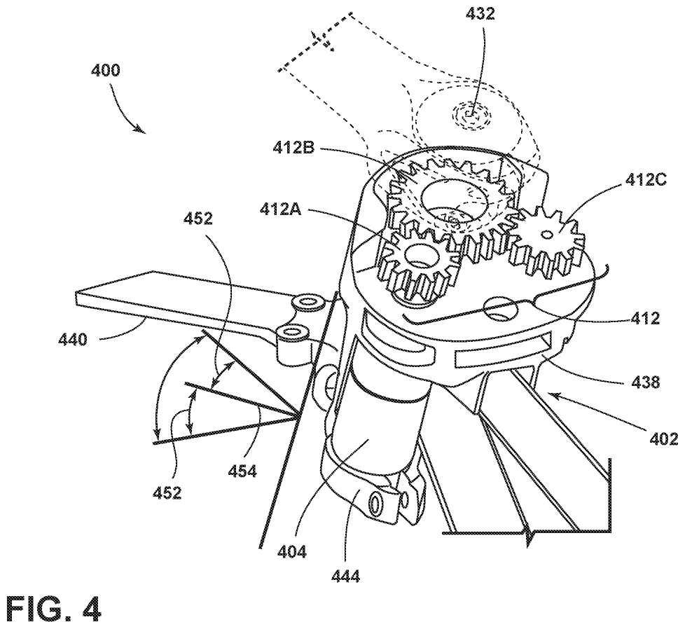

Turning now to FIG. 4, an exemplary embodiment of a steering control assembly 400 of a bicycle 402 is shown. The steering control assembly 400 can include a steering actuator 404 of a steering control system, an encoder 408, a steering column (not shown), and a gear assembly 412. The steering control assembly 400 can be enclosed in a housing (not shown) that covers the gear assembly 412, and can be electrically and/or mechanically connected to an emergency stop button (not shown), a LIDAR sensor, and a RGB camera. The housing can increase safety for an end user and provide a mounting surface and wiring support for the steering actuator 404, encoder 408, and emergency stop button. The design of the steering control assembly 400 features the actuator 404 mounted parallel to the steering column and below a gear 412A, of the gear assembly 412, attached to the steering column. The steering control assembly 400 as seen in FIG. 4 allows the end user to be able to control the bicycle 402 manually. The end user can steer the bicycle 402 with a similar amount of force required as compared to a conventional bicycle without steering control.

In order to effectively control the steering, modified steel gears 412A, 412B, 412C, with a 20° pressure angle, are attached to a motor shaft of the actuator 404 and to the steering column just below handle bars of the bicycle 402. The steering gear 412B is attached securely to the steering column using a set screw (not shown). A headset cap bolt 432 clamps and secures the handlebars and steering control assembly 400 together. The steering control assembly 400 can also include mounting hardware with a brace 438 and an armature 440 in order to mount the LIDAR sensor and/or the RGB camera. The mounting hardware can be 3-D printed. The brace 438 can be used to mount the LIDAR sensor and the RGB camera extended on the armature 440. The LIDAR sensor can be used to detect obstacles in the path of the bicycle 402 and the RGB camera can be used to identify lines on a road allowing for automation on paved roads. A lower support 444 can be attached to the bottom of the actuator 404 in order to help constrain the actuator 404 to a proper angle of operation, prevent the steering control assembly 400 from flexing, and provide stability. The actuator 404, in one example, can be a 24 V DC motor which can provide 1472 oz-in of torque at 143 rpm. The encoder 408 can be an integrated Hall Effect encoder, which can be integrated within the actuator 404. The ratio of the steering gear 412B to the gears 412A and 412C can be of 1:0.6. The ratio 1:0.6 can allow the motor to adjust a steering angle 452 of a front tire 456 of the bicycle 402 by 0.516 degrees per millisecond. The steering angle 452 can range from 00 to 450 from a center line 454. The steering angle 452 can be constrained by a suitable controller.

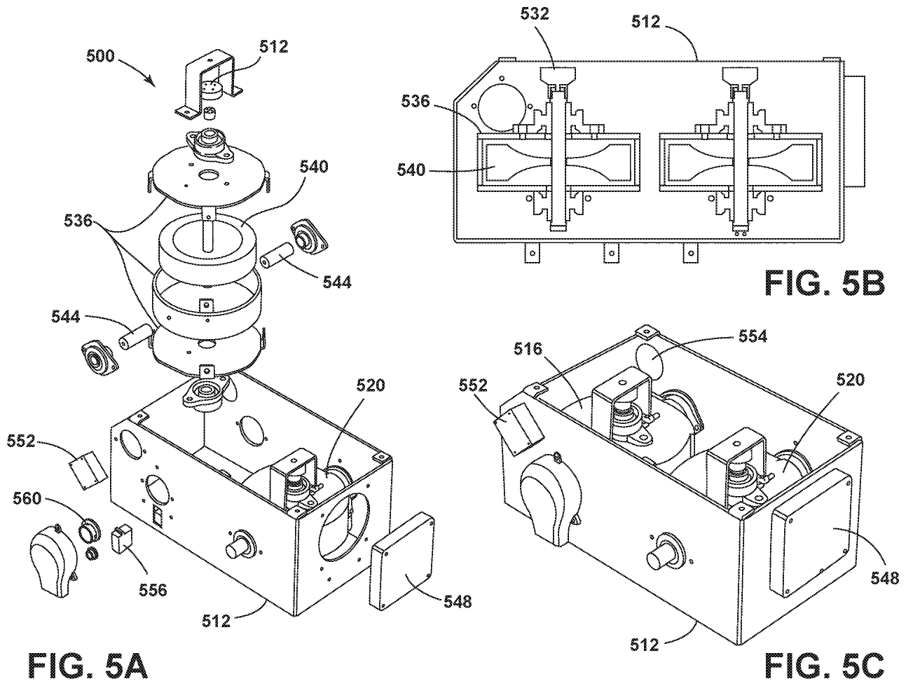

Turning now to FIG. 5, an exemplary embodiment of a CMG assembly 500 is shown. The CMG assembly 500 can be mounted above a back wheel of a bicycle. The CMG assembly 500 can include a housing 512, a microcontroller 514, a first CMG 516, a second CMG 520, a first fan 548, a second fan 552, a third fan 554, and/or a gimballing servo motor 556. The first fan 548 can be 140 mm in size. The second fan 552 and third fan 554 can be 60 mm in size. The housing 512 can be made from sheet metal bent and welded into shape. The CMGs 516, 520 can provide balancing actuation for the bicycle at low forward speeds. The use of two CMGs 516, 520 allows the CMG assembly 500 to produce a larger precessive torque than using a single CMG, which can allow the CMG assembly 500 to not only balance the bicycle, but also to assist with balancing a human rider of the bicycle. The design of the CMG assembly 500 can be seen in FIG. 5 which displays an exploded view (A), a cross sectional view through the middle of the assembly (B), and an assembled view (C). Each CMG 516, 520 can include a flywheel motor 532, a gimbal enclosure 536, a flywheel 540, and/or a gimbal axis 544. The housing 512 and gimbal enclosures 536 are made from sheet metal bent and welded into shape. The CMG's 516, 520 can be turned by a sprocket 560 and a chain 564 attached to the gimbal axis 544 of the first CMG 516 or the second CMG 520. The sprocket 548 can be actuated using the gimballing servo motor 556. The flywheel motors 532, the gimballing servo motor 556, and/or the microcontroller 514 can be cooled using the first fan 548, the second fan 552, and/or the third fan 554. Each of the flywheels 540 can be a 15 pound (6.8 kg) flywheel that can be spun at 8000 rpm in order to produce the torque needed for the CMG's 516, 520 to provide a balancing force for balancing the bicycle with a human rider. With a 250 pound human on the bicycle, a restoring force of at least 236 Newtons is needed. The restoring force requirement was calculated using standard equations developed for mini-CMG's in satellites. Thus, the CMG assembly 500 can be configured to provide a restoring force of at least 236 newtons or more such as at least 250 newtons, at least 300 newtons, or more depending on how heavy potential riders may be. The housing 512 can also contain circuitry necessary to run the gimballing servo motor 556 and the flywheel motors 532. The gimballing servo motor 556 can be controlled by a control system in order to adjust the orientation of the CMGs 516, 520 and provide an appropriate amount of force to balance the bicycle. The housing 512 can also contain a battery bank. The battery bank can be three four-cell 10 Ah Li—Po batteries to power both the circuitry, the servo motor 556, and the flywheel motors 532. The battery bank can allow the bicycle to be used for longer periods without needing to be recharged. The battery bank can also decrease the spin up time of the flywheels 540 due to the increased draw rate available from the battery bank as compared to a self-balancing bicycle system with a central battery bank powering all systems including the CMG assembly 500. The design of the housing 512 also allows for expansion of a lid, which may allow for future functionality expansion.

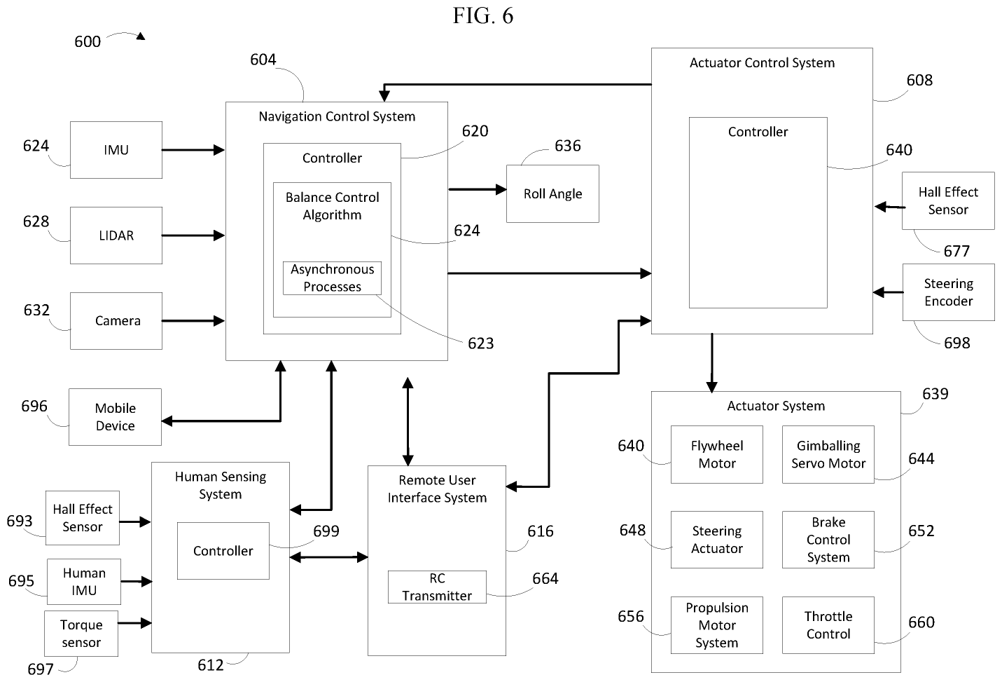

Turning now to FIG. 6, an exemplary embodiment of a balance control system 600 of a bicycle is shown. The balance control system 600 can be divided into four main subsystems: a navigation control system 604, an actuator control system 608, a human sensing system 612, and remote user interface system 616. The modular design of the balance control system 600 can improve ease of modification and enables adding high-level control features without modifying other areas of the software. The balance control system 600 can be implemented entirely on low-cost commercial hardware, and can be programmed using the C and/or Python programming languages. The navigation control system 604 can include a first controller 620. The first controller 620 can be a Raspberry Pi 3 Model B. The navigation control system 604 can be responsible for balancing and navigating the bicycle. Inputs to the navigation control system 604 can include data from an IMU sensor 626, a LIDAR sensor 628, a camera 632, and/or inputs from the other three subsystems 608, 612, and/or 616. The camera 632 can be any device for capturing images such as an RGB camera. The data can be used in a balance control algorithm 624, which can have several asynchronous processes 623 which can plan a path of the bicycle. The balance control algorithm 624 can calculate parameters input to the actuator control system 608 in order to control the motion of the bicycle 602. The data can be used in the balance control algorithm 624 to calculate an output roll angle 636 and/or send parameters to the actuator control system 608. The parameters sent to the actuator control system 608 can be based on sensed parameters and/or calculated parameters calculated in the asynchronous processes 623. The parameters sent to the actuator control system 608 can include a steering angle, a bicycle speed, a braking amount, motor speed adjustments, motor angle adjustments, steering angle adjustments (e.g. a change in the steering angle), braking commands, acceleration commands, or any other command suitable for controlling the movement of the bicycle and/or the actuation of an actuator system 639 including a flywheel motor 640, a gimballing servo motor 644, a steering actuator 648, a brake control system 652, a propulsion motor system 656, and/or a throttle control 660. The actuator control system 608 can also be coupled to a steering encoder 698 in order to receive a steering angle value. The actuator control system 608 can also be coupled to a first Hall Sensor in order to receive a speed value of the bicycle.

The actuator control system 608 can be run on one or more controllers 640 coupled to the first controller 620. The actuator control system 608 can be coupled to the actuator system 639. Each of the one or more controllers 640 can be suitable for receiving commands and actuating one or more actuator systems including the flywheel motor 640, the gimballing servo motor 644, the steering actuator 648, the brake control system 652, the propulsion motor system 656, and/or the throttle control 660. Alternatively, the navigation control system 604 can include the actuator control system 608. The one or more controllers 640 can receive target values for the steering angle, bicycle speed, braking amount, motor speed adjustments, motor angle adjustments, steering angle adjustments, braking commands, and/or acceleration commands over a serial connection to the navigation control system 604, and can control the actuator system 639 in order to achieve these targets. The one or more controllers 640 can be Cypress PSoC 5LP microcontrollers. The PSoC 5LP is an ideal microcontroller for this application because its hardware can be configured to perform tasks that would otherwise require additional computational resources. The 32-bit Arm Cortex-M3 CPU in the PSoC 5LP also has ample computational capacity to run several interrupt-based control loops required to manage the bicycle speed and steering angle. The one or more controllers 640 can also periodically send data about the current conditions of the bicycle back to the first controller 620 for use in the balance control algorithm 624.

The remote user interface system 616 can contain an RC transmitter 664 used to provide reliable manual input to the bicycle control system during operation, and a tablet or other computer used to display real-time information about the bicycle system. The RC transmitter 664 can communicate with the navigation control system 604, the actuator control system 608, and/or the human sensing system 612 via a 2.4 GHz RC receiver 665 connected to the one or more controllers 640 via Futaba S.Bus protocol. The first controller 620 can provide a wireless network that mobile devices 696 can connect to in order to display real-time data

The human sensing system 612 can be coupled to the navigational control system 604. The human sensing system 612 can have a third controller 699. The third controller 699 can be coupled to a human IMU sensor 695 in order to receive a human movement value of a human rider sensed by the human IMU sensor 695. The human IMU sensor 695 can be mounted on a human rider. The third controller 699 can also be coupled to a torque sensor 697 in order to receive a torque value sensed by the torque sensor 697. In one example of an asynchronous process 623, a steering intention of the human rider may be calculated in the first controller 620 from the torque value. If the steering intention may cause harm to the human rider, the first controller 620 may command the steering actuator 648 to keep a target steering angle to a safe range. Additionally, the balance control algorithm 624 can calculate a relative motion value, which can be a motion vector of the human rider relative to the bicycle frame. The relative motion value can be used to send commands to CMG actuators such as the gimballing servo motor 644 and/or the flywheel motor 640 in order to balance the bicycle appropriately. Additionally, the third controller 699 can be coupled to a second Hall sensor 693. The second Hall sensor 693 can sense a speed of the pedals of the bicycle in order to determine a human rider pedal value. If the human rider input value is below a certain threshold, the first controller 620 may send commands to the propulsion motor system 656 in order to increase the speed of the bicycle.

In some embodiments, the first controller 620 can execute the balance control algorithm to steer the bicycle. The balance control algorithm may receive a sensed roll angle value from the IMU sensor 626 and/or a sensed steering angle value from the steering encoder 698, and calculate a target steering angle. The target steering angle can then be used to determine commands sent to the actuator system. Commands can include actuating the steering actuator 648 to a specified angle, actuating the flywheel motor 640 to a specified speed, actuating the gimballing servo motor 644 to a specified angle, actuating the propulsion motor system 656 to a specified speed, a combination thereof, or other appropriate commands.

In an alternative embodiment, the balance control system 600 can be run on a single controller appropriately coupled to the sensors and/or actuators utilized by the balance control system 600.

### EXAMPLES

### Example 1: Steering Control and Hardware Experiments

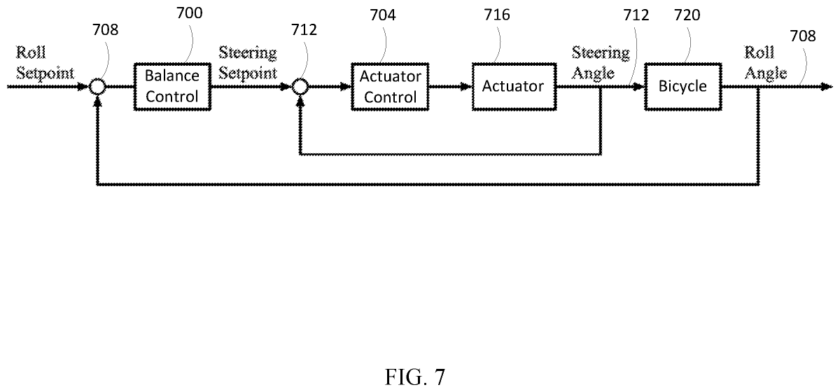

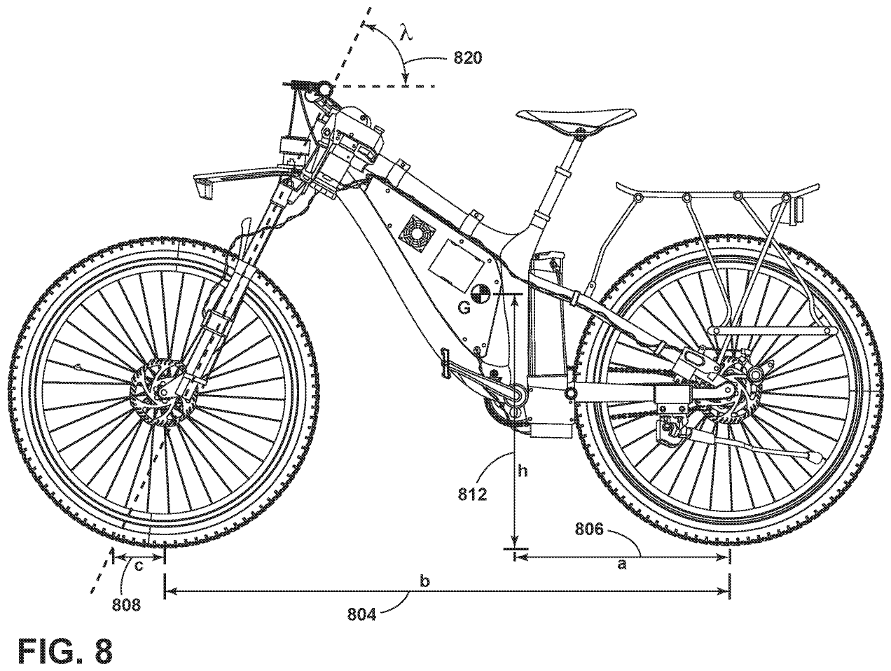

In this experiment, the bicycle dynamics are fully defined by 25 parameters. Many assumptions and linearizations need to be made in order to apply model-based control, and the effectiveness of the controller cannot be guaranteed due to error in measuring the parameters on the bike, such as moments of inertia. The model-based controller is difficult to transfer to a different bicycle due to the difficulties of accurately measuring all the dynamic parameters. Instead of model-based control, model-free control methods design the control system without any explicit information about the model itself and can be more easily applied on different hardware platforms once the effectiveness has been verified. Proportional-integral-derivative (PID) control processes are one of the model-free control approaches and have been widely used in control engineering practice for several decades. The biggest advantages of the PID control process are that it can be tuned and adjusted on-site by experiment on the controller plant and fine tuning of the controller can be achieved based on tuning rules. FIG. 7 illustrates the overall control systems design, with a balance control algorithm 700 and an actuator control 704 on a bicycle 720. The input into the system is a roll angle 708 of the bicycle measured by an IMU and the output is a steering angle 712 controlled by a steering actuator 716. HC indicates the balance control algorithm 700, and LC indicates the actuator control 704. The PID control process for balancing is implemented in Python on the Raspberry Pi. The current angular rates are captured from the PhidgetSpatial IMU sensor at a frequency of 200 Hz and are integrated, using the Runge-Kutta fourth-order method, to approximate the current roll angle. Sensor drift is reduced by passing the approximate roll angle determined from the high frequency IMU data through a complementary filter with the roll angle calculated from the low-frequency accelerometer data. Readings from the accelerometer are filtered by discarding any data where the component of acceleration normal to the bicycle's direction of motion is outside (0.8, 1.2) g. The low-level steering actuator controller is implemented on the actuator control PSoC and is driven by a timer at 200 Hz. During the PID tuning process, the target roll angle is set to zero and the target speed is set based on the velocity to be tested. The balance controller is configured such that the control parameters can be adjusted from the RC transmitter during bicycle operation, and these parameters are initialized based on extrapolation of the values obtained from previous tests. For example, to determine the initial control parameters for 2.6 m/s motion of the bicycle, Kp was initialized to 1.0 and gradually increased until the bicycle could maintain balance for several seconds. However, introduction of the derivative term allowed more stable operation of the bicycle for longer periods of running time. FIG. 8 shows the bicycle structure with corresponding parameters labeled. The values of those measured parameters are summarized in Table 1.

TABLE 1
Summary of Bicycle Parameters

| a 800 | b 804 | c 808 | h 812 | m | λ 820 |
|---|---|---|---|---|---|
| 0.46 m | 1.15 m | 0.11 m | 0.48 m | 27 kg | 1.31° |

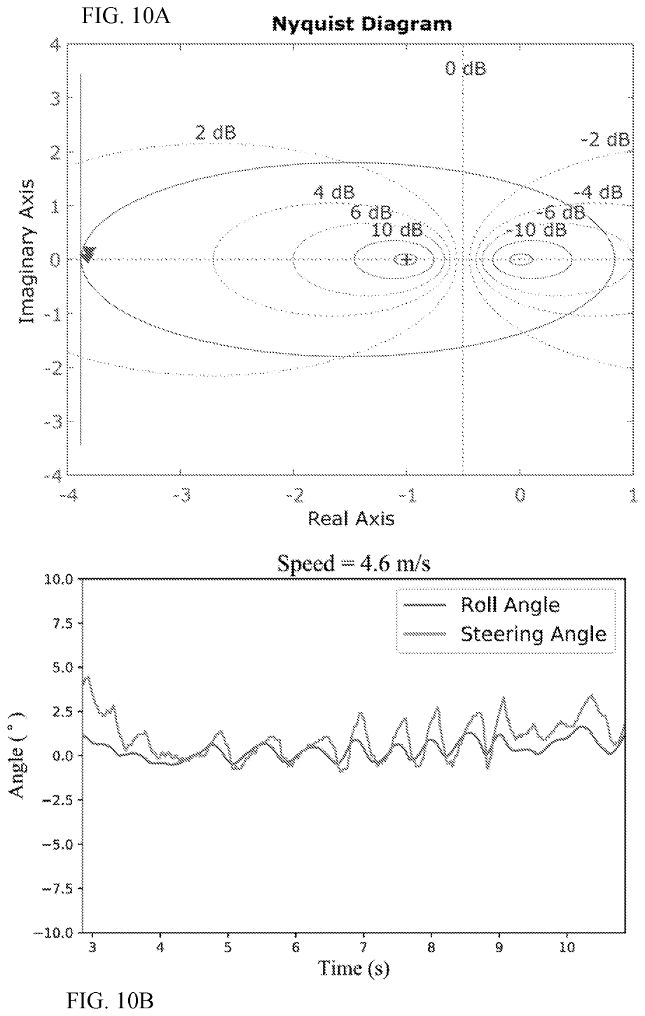

The balance controller has also been verified by simulation based on MBC. Based on a dynamic model of constant-velocity steering control, the transfer function of the bicycle is:

$$G ( s ) = \frac{φ ( s )}{δ ( s )} = \frac{ahv \cdot sin ( λ ) s - mcag \cdot {sin}^{2} ( λ )}{b ( {h}^{2} {s}^{2} - gh )} \qquad ( 1 )$$

where ϕ(s) is the roll angle of the bicycle and δ(s) is the steering angle. In equation (1), m is the mass of the bicycle, a is the horizontal distance between the center of gravity and the contact point of the rear wheel and ground, b is the horizontal distance between the contact points of front and rear wheel and ground, c is the trail, h is the height of the center of gravity, A is the fork angle and v is the velocity of the bicycle. Based on this model, simulations have been conducted to verify the effectiveness of our approach. Nyquist plots for selected speeds have been presented in FIGS. 10(a)-12(a) and one can see that there are two counter-clockwise encirclements of −1. As a result, there are no right-hand closed-loop poles considering that the open-loop transfer function shown in (1) has two unstable poles. Therefore, the closed-loop system is stable.

A self-balancing bike prototype was built in order to verify the effectiveness of the hardware development and steering controller. The experiment was performed at seven different constant forward speeds, ranging from 2 m/s to 5 m/s. Table 2 below is the summary of the velocities and corresponding control parameters. The prototype can run stably under those control parameters with a constant forward speed.

TABLE 2

| Speed (m/s) | Kp | Ki | Kd |
|---|---|---|---|
| 2.0 | 5.00 | 0.01 | 0.35 |
| 2.6 | 3.59 | 0.01 | 0.23 |
| 3.0 | 3.22 | 0.01 | 0.23 |
| 3.6 | 2.77 | 0.01 | 0.23 |
| 4.0 | 2.28 | 0.01 | 0.23 |
| 4.6 | 2.25 | 0.01 | 0.23 |
| 5.2 | 2.23 | 0.01 | 0.208 |

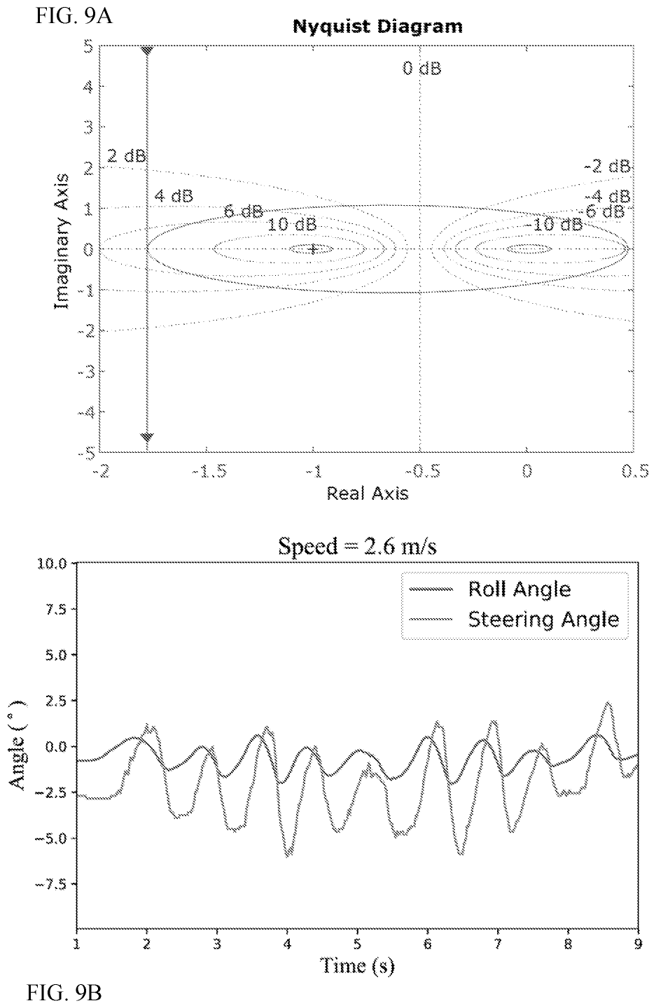

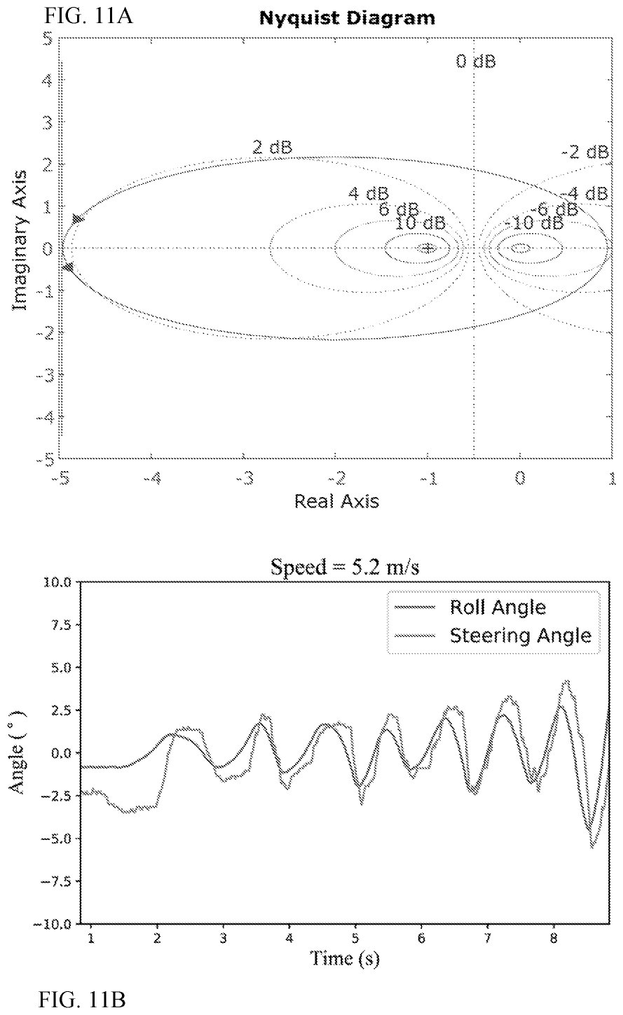

FIGS. 9, 10, and 11 show the Nyquist diagrams and the actual performance of the balance controller at selected bicycle speeds. At velocities above 3.0 m/s the bicycle was able to maintain balance for the entire length of the test track. In this experiment, a design for a self-balancing bicycle was presented and discussed. The effectiveness of a data-driven control process (PID control process) has been verified by both simulation and implementation on a hardware prototype. The controller can balance a bicycle at various constant forward speeds. In testing, the controller was able to balance the bicycle at a forward velocity of 4.6 m/s. FIG. 9A shows a graph of closed-loop analysis and FIG. 9B shows a graph of experimental results at 2.6 m/s. FIG. 10A shows a graph of closed-loop analysis and FIG. 10B shows a graph of experimental results at 4.6 m/s. with a reliable performance. The primary goals of this study were to design and implement the hardware for a self-balancing bicycle and to build a research platform for the further study of automated driving of bicycles, balance algorithms, and human-bicycle interaction. FIG. 11A shows a graph of closed-loop analysis and FIG. 11B shows a graph of experimental results at 5.2 m/s.

Both hardware and control algorithms for self-driving bicycle have been developed, and a variety of sensors were applied on the system to achieve environmental awareness. In addition, the sensors implemented on the bike can be further utilized to gain a more complete environmental awareness, allowing for increased autonomy because the controller, via the sensors, can more accurately model the environment and improve the algorithmic reaction of the controlled balancing systems. Beyond improving the self-balancing actuation of the system and its environmental awareness, the bicycle can be used as a platform for other forms of research. Some of these research topics could include environmental modeling of areas unreachable by cars, bike sharing applications, rehabilitation applications, bicycle-car interaction, bicycle-UAV interaction, and research on bicycle-human interaction. This study has large potential to generate data which can be used in both self-driving algorithms and human robot-interactions.

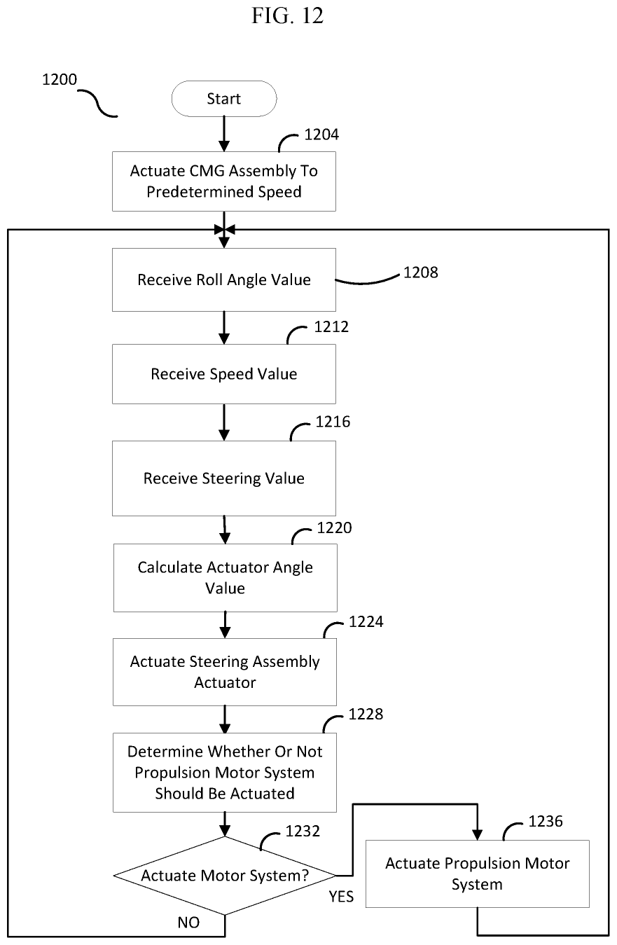

Referring now to FIG. 12, a process 1200 for balancing a bicycle is shown. The process 1200 can be implemented as instructions (i.e., machine code) on one or more memories and executed by one or more processors. The memories and/or processors can be included in one or more controllers coupled to the bicycle.

At 1204, the process 1200 can actuate at least one motor included in a control motion gyroscope (CMG) assembly to a predetermined speed. For example, the process 1200 can actuate two flywheel motors included in a CMG assembly to 8000 RPM as described above. The CMG assembly can be mounted to the bicycle and provide a restoring force to the bicycle and/or operator. The process 1200 can then proceed to 1208.

At 1208, the process 1200 can receive a roll angle value from a sensor coupled to the bicycle. The sensor can be an IMU sensor as described above. The process can then proceed to 1212.

At 1212, the process 1200 can receive a speed value from a speed sensor coupled to the bicycle. The speed sensor can be a Hall Effect sensor as described above. The process 1200 can then proceed to 1216.

At 1216, the process 1200 can receive a steering angle of the bicycle from a steering angle sensor such as the steering encoder described above. The steering angle can be associated with an angular position of front forks of the bicycle. The process can then proceed to 1220.

At 1220, the process 1200 can calculate an actuator angle value based on the roll angle value, the steering angle, a predetermined range of acceptable steering angle values, and/or a predetermined target roll angle. As described above, a PID control process implemented as a process (i.e. in Python) for balancing the bicycle can be used to determine an actuator angle value (i.e. a steering angle for the steering assembly actuator). The process may also determine whether or not the current steering angle is outside the range of acceptable steering angle values, and potentially replace the actuator angle value output by the PID control process to ensure that the actuator angle value is within the range acceptable steering angle values. The predetermined target roll angle used by the PID control process can be zero. The process 1200 can then proceed to 1224.

At 1224, the process 1200 can actuate an actuator coupled to a steering assembly to the actuator angle value. The steering assembly can be the steering assembly 400 described above. The steering assembly can include at least two gears. The process 1200 can then proceed to 1228.

At 1228, the process 1200 can determine whether or not a propulsion motor system should be actuated. The propulsion motor system can be the propulsion motor system 128 described above. The process 1200 can determine whether or not the speed value is below a predetermined threshold value, which may correspond to a target speed value of the PID process. If the speed value is below the threshold value, the process 1200 can determine that the propulsion motor system should be actuated. If the speed value is not below the threshold value, the process 1200 can determine that the propulsion motor system should not be actuated. The process can then proceed to 1232.

At 1232, if the process 1200 determined that the propulsion motor system should be actuated (e.g., “YES” at 1232), the process 1200 can proceed to 1236. If the process 1200 determined that the propulsion motor system should not be actuated (e.g., “NO” at 1232), the process 1200 can proceed to 1208.

At 1236, the process 1200 can actuate the propulsion motor system coupled to the bicycle based on the speed value. The propulsion system may in turn increase the speed of the bicycle. The process can then proceed to 1208.

The present invention has been described in terms of one or more preferred embodiments, and it should be appreciated that many equivalents, alternatives, variations, and modifications, aside from those expressly stated, are possible and within the scope of the invention. The appended document describes additional features of the present invention and is incorporated herein in its entirety by reference.

What is claimed is:

1. A self-balancing bicycle system comprising:
a bicycle;
a sensor coupled to the bicycle;
a steering control assembly comprising an actuator and being coupled to the bicycle and configured to adjust a steering angle of a front tire of the bicycle; and
a controller coupled to the sensor and configured to receive a value from the sensor, the controller further coupled to the steering control assembly and further configured to adjust the steering angle based on the value.

2. The system of claim 1, wherein the sensor is an inertial measurement unit and the value is a roll angle value of the bicycle.

3. The system of claim 2, wherein the controller is coupled to the actuator and further configured to:
calculate an actuator angle value based on the roll angle value and a predetermined target roll angle; and
actuate the actuator to the angle value.

4. The system of claim 1, wherein the sensor is an encoder and the value is a sensed steering angle value of the bicycle.

5. The system of claim 1 further comprising a control motion gyroscope (CMG) assembly coupled to the bicycle, the CMG assembly comprising a control motion gyroscope and a motor configured to adjust the orientation of the at least one control motion gyroscope, the CMG assembly being configured to provide a restoring force to the bicycle.

6. The system of claim 5, wherein the bicycle comprises a back rack, and wherein the CMG assembly is directly coupled to the back rack.

7. The system of claim 1, wherein the steering assembly further comprises:
a first gear coupled to the actuator and configured to be rotated by the actuator; and
a second gear coupled to a steering column of the bicycle and engaged with the first gear,
wherein the controller is further configured to actuate the actuator based on the value.

8. The system of claim 7, wherein the first gear has less teeth than the second gear.

9. The system of claim 7, wherein the steering control assembly is configured to allow an operator to manually control steering of the bicycle.

10. The system of claim 1 further comprising a control motion gyroscope (CMG) assembly coupled to the bicycle, the CMG assembly comprising at least two control motion gyroscopes, each gyroscope comprising a flywheel and a flywheel motor, the CMG assembly being configured to provide a restoring force of at least 250 Newtons.

11. A self-balancing bicycle system comprising:
a bicycle;
a sensor coupled to the bicycle;
a control motion gyroscope (CMG) assembly coupled to the bicycle, the CMG assembly comprising a control motion gyroscope and a motor configured to adjust the orientation of the at least one control motion gyroscope, the CMG assembly being configured to provide a restoring force to the bicycle.

12. The system of claim 11 wherein the CMG assembly comprises a second control motion gyroscope comprising a flywheel and a flywheel motor, and wherein the CMG assembly is configured to provide a restoring force of at least 250 Newtons.

13. The system of claim 11, wherein the bicycle comprises a back rack, and wherein the CMG assembly is directly coupled to the back rack.

14. The system of claim 11 further comprising:
a sensor coupled to the bicycle;
a steering control assembly comprising an actuator, the steering control assembly being coupled to the bicycle and configured to adjust a steering angle of a front tire of the bicycle, and
a controller coupled to the sensor and the steering control assembly, the sensor being configured to receive a value from the sensor, the controller being further configured to adjust the steering angle based on the value.

15. The system of claim 14, wherein the steering assembly further comprises:
a first gear coupled to the actuator and configured to be rotated by the actuator; and
a second gear coupled to a steering column of the bicycle and engaged with the first gear,
wherein the controller is further configured actuate the actuator based on the value.

16. The system of claim 15, wherein the first gear has less teeth than the second gear.

17. The system of claim 15, wherein the steering control assembly is configured to allow an operator to manually control steering of the bicycle.

18. The system of claim 14, wherein the sensor is an inertial measurement unit and the value is a roll angle value of the bicycle.

19. A method for balancing a bicycle comprising:
receiving a roll angle value from a sensor coupled to the bicycle;
calculating an actuator angle value based on the roll angle value and a predetermined target roll angle; and
actuating an actuator coupled to a steering assembly to the actuator angle value, the steering assembly comprising at least two gears.

20. The method of claim 19 further comprising:
actuating at least one motor included in a control motion gyroscope (CMG) assembly to a predetermined speed,
wherein the CMG assembly is coupled to a back rack of the bicycle and configured to provide a restoring force to the bicycle.
